(19) United States
(12) Patent Application Publication
(10) Pub. No.: US 2006/0232977 A1
(43) Pub. Date: Oct. 19, 2006

(54) Lens assembly

(76) Inventors: Ching-Hsien Hwang, Tainan (TW); Hsiang-Chen Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/104,462

(22) Filed: Apr. 13, 2005

(51) Int. Cl. F21V 7/00

(52) U.S. Cl. 362/341

(57) ABSTRACT

A light lens assembly includes a reflector and a lamp is located at a center of the reflector. A support member is mounted to an open side of the reflector and a lens is connected to the support member so that the light form the lamp goes through lens. The lens is made by optical material and an oxide film for stopping infrared and ultraviolet lights is coated on a surface of the lens.

### FIELD OF THE INVENTION

The present invention relates to a lens assembly that is made by optical material and light in weight, an oxide film is coated on the lens to stop infrared and ultraviolet lights entering the lens.

### BACKGROUND OF THE INVENTION

A conventional lens assembly used on vehicle head light assemblies or projectors is shown in FIG. 5 and generally is a glass lens “A”. However, the molds for manufacturing the glass lens have to bear very high temperature and are worn out quickly or cost much in mold materials . The glass lens needs extra work to grind so that it can only be produced in mass production by much hand carfts . Besides, it is not economic to re-use the glass lens materials . The glass lens is so heavy that 40% to 60% weight of the whole head light assembly is from the glass lens. Therefore, the center of weight of the whole head light assembly is located at front end thereof, especially for the Adaptive Front-Lighting System (AFS), and the reflector could be deformed by the heavy glass lens. Furthermore, the heavy glass lens increases the load of the electric adjustment device for headlamps.

The present invention intends to provide a lens assembly that is light in weight and needs no extra grinding processes.

### SUMMARY OF THE INVENTION

The present invention relates to a light lens assembly that comprises a reflector with a lamp located at a center of the reflector and a support member is mounted to an open side of the reflector. A lens is connected to the support member and made by optical material. An oxide film is coated on a surface of the lens and the surface faces the lamp.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the lens assembly of the present invention;

FIG. 2 is a side view to show the lens assembly of the present invention;

FIG. 3 is a cross sectional view to show the lens assembly of the present invention;

FIG. 4 shows light beams go through the lens of the present invention, and

FIG. 5 shows light beams go through a conventional glass lens.

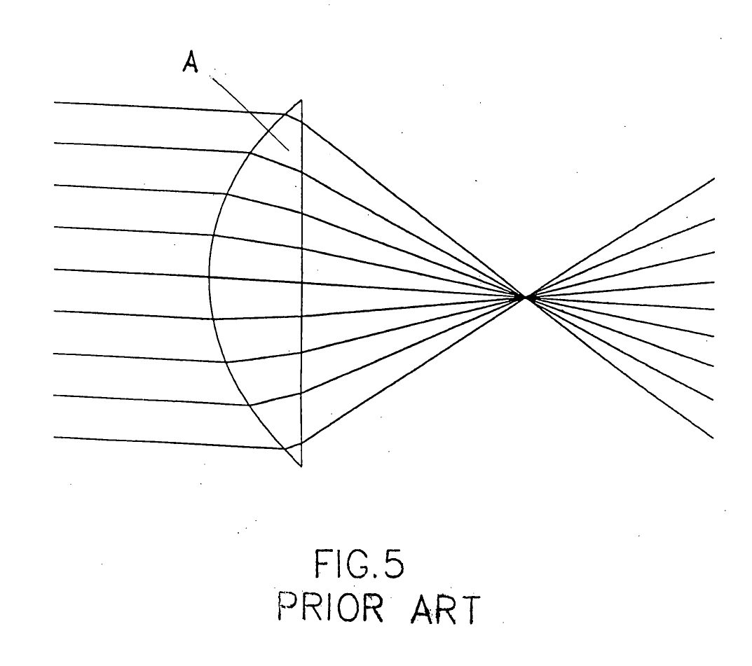

### DETAILED DESCRIPTION OF THE PREFERRED EMBODIMENT

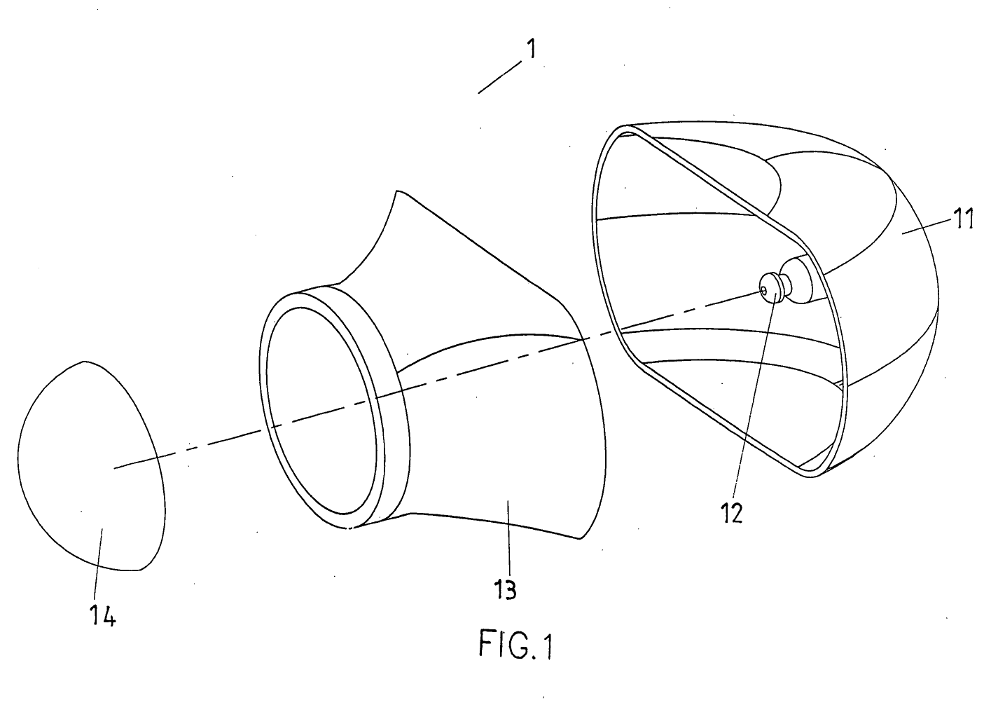

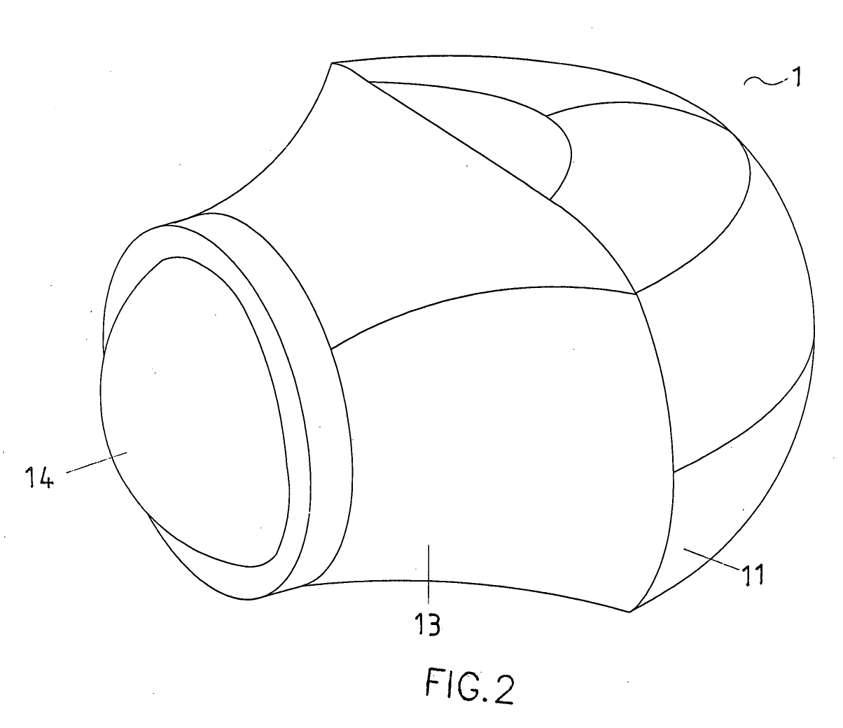

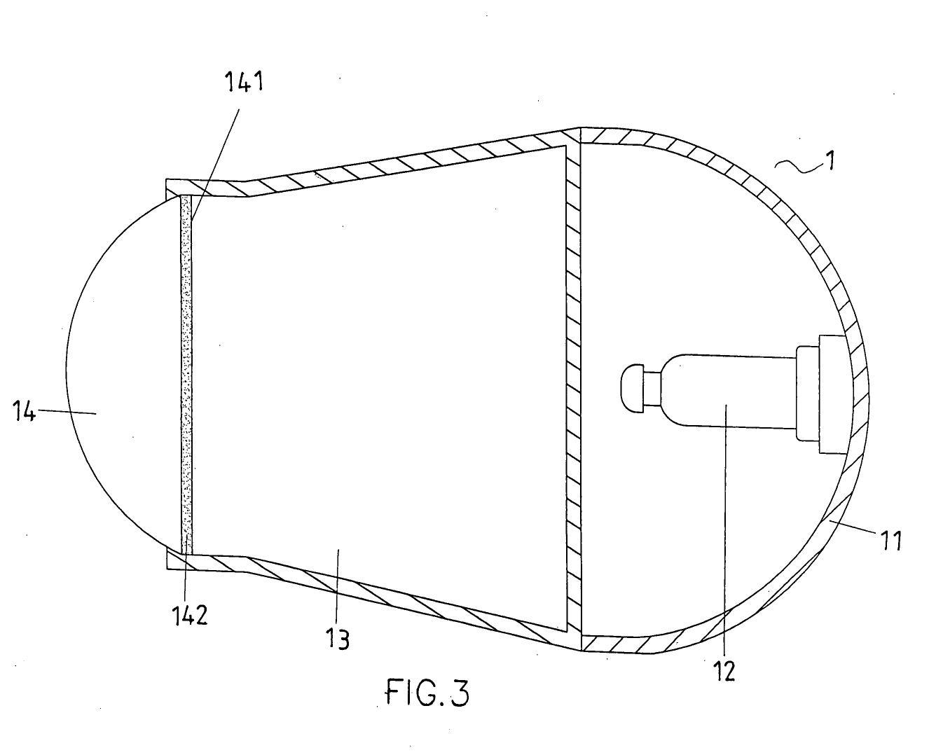

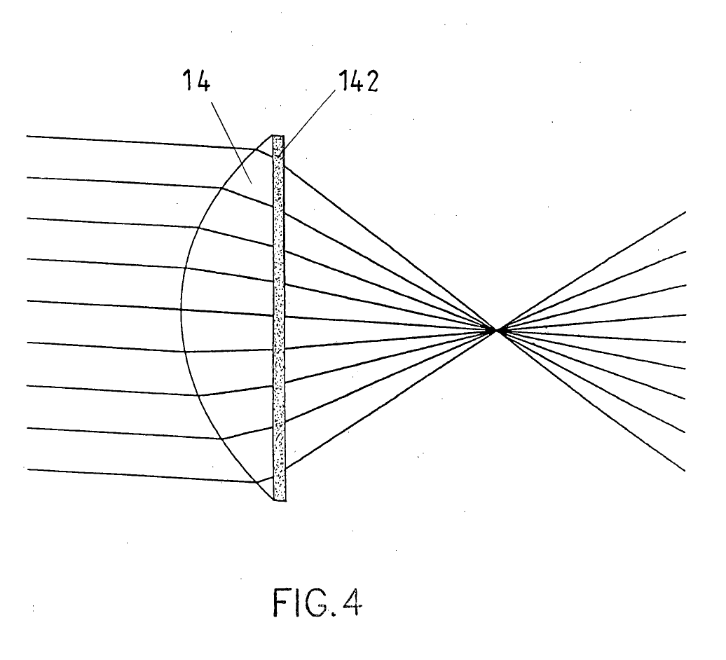

Referring to FIGS. 1 to 4, the lens assembly 1 of the present invention comprises a reflector 11 and a lamp 12 is located at a center of the reflector 11. A support member 13 is mounted to an open side of the reflector 11 and a lens 14 is connected to the support member 13. The lens 14 is a converging lens and made by optical material. An oxide film 142 is coated on a surface of the lens 14 and the surface is a flat surface and faces the lamp 12. The oxide film 142 can stop infrared and ultraviolet lights entering the lens 14.

The lens 14 can be made by way of plastic injection molding so that it is suitable to be produced in mass production. No extra grinding processes are required for the lens 14. The lens 14 is light in weight and conveniently to be made into aspherical lenses and Fresnel lenses. The light in weight of the lens 14 is easily driven by the headlamp's electric adjustment device. The weight of the lens 14 is 60% less than the conventional glass lens. The lens assembly can also be used for vehicle head light assemblies or projectors.

While we have shown and described the embodiment in accordance with the present invention, it should be clear to those skilled in the art that further embodiments may be made without departing from the scope of the present invention.

What is claimed is:

1. A light lens assembly comprising:
a reflector and a lamp located at a center of the reflector, a support member mounted to an open side of the reflector, and a lens connected to the support member, the lens being a converging lens and made by optical material, an oxide film coated on a surface of the lens.

2. The assembly as claimed in claim 1, wherein the oxide film is coated on the surface that faces the lamp.

3. The assembly as claimed in claim 1, wherein the surface is a flat surface.
